(19) United States
(12) Patent Application Publication
(10) Pub. No.: US 2007/0061234 A1
(43) Pub. Date: Mar. 15, 2007

(54) Hedge accounting method and system

(75) Inventor: Elie R. Zabal, Franklin Lakes, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Investment Support Systems, Inc., Parsippany, NJ (US)

(21) Appl. No.: 11/501,639

(22) Filed: Aug. 9, 2006

Related U.S. Application Data
(60) Provisional application No. 60/717,474, filed on Sep. 15, 2005.

(51) Int. Cl. G06Q 40/00

(52) U.S. Cl. 705/36 R

(57) ABSTRACT

Methods and systems for identifying pairings of transactions that constitute or establish hedging relationships and determining the eligibility of particular financial instruments for hedge-accounting treatment. The methods and systems permit a user to generate a new forecasted transaction to be associated with the selected financial instrument. Data is generated indicative of whether the selected financial instrument and the new forecasted transaction establish a valid hedging relationship and whether the financial instrument originally associated with the selected forecasted transaction establishes or would have established a valid hedging relationship with the new forecasted transaction in accordance with the hedge-accounting criteria.

### CROSS-REFERENCE TO RELATED APPLICATIONS

This application claims the benefit of the filing date of U.S. Provisional Patent Application No. 60/717,474 filed Sep. 15, 2005, the disclosure of which is hereby incorporated herein by reference.

### BACKGROUND OF THE INVENTION

The present invention relates to methods and systems for hedging risks, and particularly relates to identifying pairings of transactions that constitute or establish hedging relationships and determining the eligibility of particular financial instruments for hedge-accounting treatment.

Hedges are financial instruments, typically derivatives (such as forward contracts, options and swaps) that are used to hedge the risks associated with transactions or exposures forecasted to occur in the future. Portfolio managers, individual investors and corporations use hedging techniques to reduce their exposure to various risks. In financial markets, investors hedge against investment risk by strategically using financial instruments to offset the risk of adverse price movements in other investments.

To hedge, one invests in two securities with negative correlations. This can be illustrated with an example in which an investor owns shares of a food-processing company. The investor considers the long-term prospects for the company to be favorable, but is concerned about a short-term drop in share prices. To protect against this short-term risk, the investor can buy a put option, which is an option contract conferring the right—but not the obligation—to sell a specified amount of the underlying security at a specified price (called the “strike price” or “reference price”) within some period of time. In this case, the shares are currently trading at $50. If the investor buys a put option conferring the right to sell shares of the company at $50 within the next three months, the investor hedges against the risk of a price drop in the next three months. Thus, if share prices drop to $45 within the next three months, the investor can exercise his option to sell shares at $50. (Although the investor is “selling” shares he does not actually own, this is permitted by the option contract, and the investor is permitted to “buy” those same shares retroactively, at current market prices, after selling them.) Because the shares sold pursuant to the option contract at $50 only cost the investor $45 to buy, the investor renders a profit of $5 per option. Thus, price gains in the put options offset the investor's losses in his original shares (which dropped from $50 to $45).

Another example of hedging involves offsetting risks associated with changes in commodity prices. The same food-processing company might be worried about volatility in the price of corn, which the company uses to make corn oil. To protect or hedge against rising corn prices, which would increase the company's costs, the company can buy a futures contract, which is a contract to purchase a specific amount of a commodity at a specific price on a specific date in the future. In this case, the futures contract would give the company the right to buy corn at a fixed price on a particular date, and would hedge against an increase in the price of corn. If the price of corn were to rise above the reference price specified in the futures contract during the contract period, the company could buy corn at the lower price specified in the contract.

Under Financial Accounting Standards Board Statement No. 133, as amended (hereinafter “FAS 133”), which governs the accounting treatment of derivative instruments and hedging activities, some or all of the income (or loss) on a financial instrument may be deferred (and not “marked-to-market”) if the financial instrument qualifies as an effective hedge for a forecasted transaction or exposure. FAS 133 requires, at least for cash-flow hedges, that the hedged forecasted transaction or exposure be documented and that the documentation “include all relevant details, including the date on or period within which the forecasted transaction is expected to occur . . . .” See FAS 133, Paragraph 28(a).

As noted in the discussion of Issue No. G16 (a commentary to FAS 133 issued by the Derivative Implementation Group (“DIG”)), the expected timing of a forecasted transaction may change. If that occurs, the entity must then determine whether the hedging instrument still serves as an effective hedge for the forecasted transaction or exposure within the meaning of FAS 133 (see, in particular, Paragraphs 28 and 29). If the hedging instrument no longer qualifies as an effective hedge, the entity must report income (or loss) on that instrument immediately, which may be undesirable, unless the entity can establish prospective effectiveness. The entity, therefore, may choose to purchase a new derivative instrument to hedge the forecasted transaction with its new forecast date.

There is a need, therefore, to provide a system and method to minimize unfavorable accounting treatment of income (or loss) on financial instruments that may occur, for example, if hedge-accounting treatment is unavailable and an entity is required to report income (or loss) immediately.

### SUMMARY OF THE INVENTION

The present invention solves these and other needs by providing methods and systems for analyzing, documenting and determining the accounting treatment for hedging relationships, and for identifying financial instruments that may be eligible for hedge-accounting treatment. One preferred embodiment of the present invention provides a computer-implemented method for identifying pairings of transactions that establish valid hedging relationships in compliance with hedge-accounting criteria and for determining eligibility of financial instruments for hedge-accounting treatment. This method includes: accessing one or more computer databases containing one or more financial instruments and one or more forecasted transactions; selecting a financial instrument as a potential hedge from the one or more financial instruments; selecting a forecasted transaction already associated with a financial instrument in a hedging relationship from the forecasted transactions; generating a new forecasted transaction to be associated with the selected financial instrument; processing data associated with the selected financial instrument and data associated with the new forecasted transaction in accordance with hedge-accounting criteria to generate first hedging data indicative of whether the selected financial instrument and the new forecasted transaction establish a valid hedging relationship in accordance with the hedge-accounting criteria; processing data associated with the financial instrument originally associated with the selected forecasted transaction and data associated with the new forecasted transaction in accordance with hedge-accounting criteria to generate second hedging data indicative of whether the financial instrument originally associated with the selected forecasted transaction establishes or would have established a valid hedging relationship with the new forecasted transaction in accordance with the hedge-accounting criteria; and designating the selected financial instrument as a hedge for the new forecasted transaction if the first and second hedging data indicate the existence of valid hedging relationships.

Another preferred embodiment of the present invention provides a system for identifying pairings of transactions that establish valid hedging relationships in compliance with hedge-accounting criteria and for determining eligibility of financial instruments for hedge-accounting treatment. The system includes a computer, in communication with one or more databases and a user input device, comprising a microprocessor; and the one or more databases storing one or more financial instruments and one or more forecasted transactions. The microprocessor is programmed to allow a user to select one or more financial instruments as a potential hedge from the one or more financial instruments; allow a user to select a forecasted transaction already associated with a financial instrument in a hedging relationship from the forecasted transactions; generate a new forecasted transaction to be associated with the selected financial instrument; process data associated with the selected financial instrument and data associated with the new forecasted transaction in accordance with hedge-accounting criteria to generate first hedging data indicative of whether the selected financial instrument and the new forecasted transaction establish a valid hedging relationship in accordance with the hedge-accounting criteria; process data associated with the financial instrument originally associated with the selected forecasted transaction and data associated with the new forecasted transaction in accordance with hedge-accounting criteria to generate second hedging data indicative of whether the financial instrument originally associated with the selected forecasted transaction establishes or would have established a valid hedging relationship with the new forecasted transaction in accordance with the hedge-accounting criteria; and allow a user to designate the selected financial instrument as a hedge for the new forecasted transaction if the first and second hedging data indicate the existence of valid hedging relationships.

Yet another preferred embodiment of the present invention provides a computer-readable storage medium storing a program for instructing a computer to execute actions. The actions include: requesting a user to select a financial instrument as a potential hedge from one or more financial instruments in one or more computer databases; requesting the user to select a forecasted transaction already associated with a financial instrument in a hedging relationship from one or more forecasted transactions in one or more computer databases; generating a new forecasted transaction to be associated with the selected financial instrument; processing data associated with the selected financial instrument and data associated with the new forecasted transaction in accordance with hedge-accounting criteria to generate first hedging data indicative of whether the selected financial instrument and the new forecasted transaction establish a valid hedging relationship in accordance with the hedge-accounting criteria; processing data associated with the financial instrument originally associated with the selected forecasted transaction and data associated with the new forecasted transaction in accordance with hedge-accounting criteria to generate second hedging data indicative of whether the financial instrument originally associated with the selected forecasted transaction establishes or would have established a valid hedging relationship with the new forecasted transaction in accordance with the hedge-accounting criteria; and allowing a user to designate the selected financial instrument as a hedge for the new forecasted transaction if the first and second hedging data indicate the existence of valid hedging relationships.

The methods, systems and computer-readable storage media may use hedge-accounting criteria promulgated by the Financial Accounting Standards Board or criteria established by the user, for example. The criteria may include “effectiveness” tests, and may employ statistical regression analyses, such as R-squared testing.

The methods, systems and computer-readable storage media may also involve the display of one or more of the financial instruments and the forecasted transactions on a display device, and may allow the user to select and drag an indicia of the selected financial instrument to a screen location associated with the selected forecasted transaction to thereby trigger the generation of the new forecasted transaction. The new forecasted transaction may have a forecast date that corresponds to the reference date for the selected financial instrument. Upon designation of a new hedge, the system de-designates the previous hedge.

The methods, systems and computer-readable storage media also may permit a user to select two or more financial instruments at a time from the one or more financial instruments as potential hedges, and to evaluate such financial instruments for hedge-accounting treatment. The user, for example, may select and drag indicia of two or more selected financial instruments to a screen location associated with a selected forecasted transaction to thereby trigger the generation of new forecasted transactions, and to permit assessment of hedge-accounting treatment for each selected financial instrument.

The methods, systems and computer-readable storage media may permit the selection of different designation and de-designation dates for the financial instrument originally associated with the selected forecasted transaction. By evaluating several such designation and/or de-designation dates, the user may be able to select dates that establish a valid hedging relationship and may be able to reduce or minimize gain or loss on the financial instrument.

### BRIEF DESCRIPTION OF THE DRAWINGS

FIG. 1 depicts an overall system diagram of one embodiment of the present invention.

FIG. 2 is a flowchart depicting steps for identifying pairings of transactions that establish hedging relationships and for determining eligibility of financial instruments for hedge-accounting treatment in accordance with the present invention.

FIGS. 3a-3e are screen shots illustrating the operation of a computer-implemented embodiment of the present invention.

### DETAILED DESCRIPTION

The present invention permits users to select a financial instrument, select a forecasted transaction that is part of an existing hedge relationship, change (or “roll”) the forecast date for the forecasted transaction to correspond to the reference date of the selected financial instrument, and assess whether the original financial instrument could have served as an effective hedge for the new forecasted transaction (as revised with the new forecast date). With one aspect of the present invention, an entity can, therefore, take a prior existing hedge relationship and analyze whether a new forecast date is suitable for use with the original hedging instrument. Aspects of the invention also determine whether the selected (or new) financial instrument serves as an effective hedge for the new forecasted transaction (as revised with the new forecast date). With preferred embodiments of the present invention, the user does not have to change the forecast date for the forecasted transaction; rather, the system changes the forecast date on the assumption that the purchase of a financial instrument bearing a particular reference date reflects a forecast that a transaction or exposure will occur on that date and that the risk associated with such forecasted transaction or exposure is capable of being hedged.

In a computer-implemented embodiment of the present invention, a selected financial instrument (such as a forward contract for purchase of oil) can be evaluated for eligibility for hedge-accounting treatment against one or more databases of forecasted transactions or exposures, using computer-implemented calculations for desired financial and accounting parameters. Furthermore, the hedge accounting treatment for the financial instrument already associated with a forecasted transaction can be analyzed based on the revised forecast date. This permits a user to assess many possible hedging relationships (and the accounting treatment thereof) very quickly, in a manner that is forward looking and predictive. As a result, users may defer income (or loss) that they otherwise would report immediately, by securing favorable hedge-accounting treatment for financial instruments.

The present invention may also be used as part of a larger method and system for documenting and accounting for hedging activities (e.g., pursuant to FAS 133), and in connection with software such as FUTRAK® offered by Investment Support Systems, Inc. (INSSINC) of Parsippany, N.J.

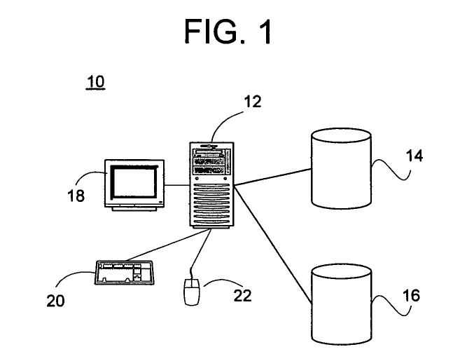

FIG. 1 illustrates one typical computer-implemented system 10 that can be used in accordance with the present invention. The system includes a computer 12, such as a standard personal computer, notebook computer, server computer, etc. Other computer devices could be used as well, such as a PDA, smart phone, etc. The computer can access a database 14, within or remote from the computer, which contains one or more financial instruments and a database 16 within or remote from the computer, which contains one or more forecasted transactions or exposures. The computer 12 can be any type of general or special purpose computer having all the components normally found in a personal computer, such as ROM, RAM, hard drive(s), modem, network cards, etc. Preferably, the computer includes a monitor 18, and is capable of supporting a graphical user interface (GUI), such as running Windows XP or similar operating system software. The computer preferably includes typical I/O devices such as a keyboard 20 and a mouse 22 for entering and retrieving information.

In a preferred embodiment, databases 14 and 16 are located within the computer (e.g., in the hard drive, in random access memory or cache memory). One or both of databases 14 and 16, however, can be external to the computer (e.g., stored on a floppy disk, memory card CD-ROM, or accessed via a server such as via the Internet or other network). Furthermore, although separate databases are shown in FIG. 1, the financial instruments and forecasted transactions or exposures can be contained in a single database within the computer or remotely accessible.

In a preferred embodiment, software for implementing the present invention is loaded on or resident in the computer 12. It may also, however, be external to the computer (e.g., on a server accessed via the Internet) and run locally or remotely.

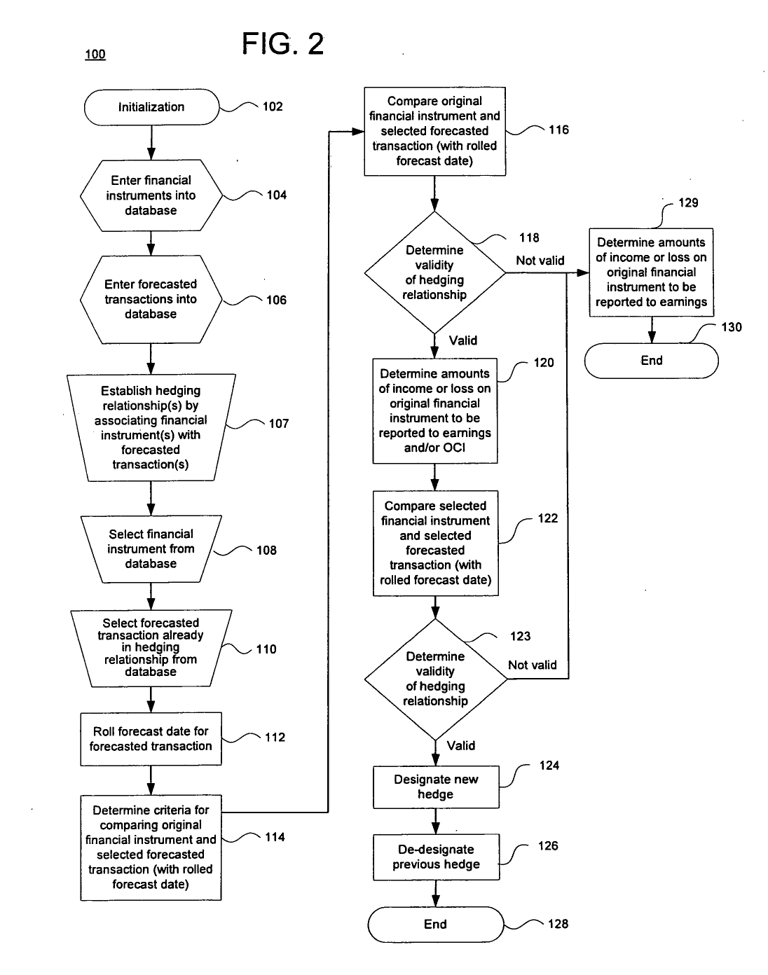

Referring to FIG. 2, a flowchart 100 of a method of identifying pairings of transactions that establish hedging relationships in accordance with the present invention is shown. The method begins with initialization in step 102. In step 104, one or more financial instruments are entered into database 14. Such financial instruments include, for example, forward contracts, options and swaps. A forward contract is a contract to purchase or sell a particular quantity of a commodity in the future at a specified price. An option is a contract conferring the right—but not the obligation—to buy or sell something at a specified price in the future. A swap is an exchange of one commodity, security, interest rate or income stream for another.

For each financial instrument, database 14 may include the following items of information: the nature of the financial instrument (e.g., forward contract, option or swap); the underlying asset on which the instrument is based (e.g., oil or another commodity); the quantity of the underlying asset involved (e.g., the amount of oil to be purchased); whether the underlying asset is to be bought or sold; the reference date; the strike price; and an identifying code or reference number for the transaction. Other pieces of data may also be included, according to the user's needs. The data for the financial instruments may also be imported from external sources (e.g., from one or more other databases) or may be input by a user.

In accordance with step 106 of FIG. 2, forecasted transactions or exposures are entered into database 16. As used herein, “forecasted transaction” refers to any forecasted transaction, exposure, risk or the like. For each forecasted transaction, database 16 may include the following items of information: the nature of exposure (e.g., the need to buy or sell a commodity at a future date); the underlying asset (e.g., oil or other commodity); the quantity of the underlying asset involved (e.g., the amount of oil to be purchased or sold); the forecasted date of the exposure; the forecasted price on the forecast date; and an identifying code or reference number for the forecasted transaction. Other pieces of data may also be included, according to the user's needs. Again, the data for the forecasted transactions may be imported from external sources (e.g., from one or more other databases) or may be input by a user. Furthermore, although the entry of financial instruments and forecasted transactions is shown in series, beginning with the financial instruments in step 104, the entry or importation of financial instruments and forecasted transactions may occur in any order or in parallel.

In a preferred embodiment, the system automatically creates a forecasted transaction in response to answers to a series of questions directed to the user after the user has selected a financial transaction from the database of financial transactions.

In accordance with step 107 of FIG. 2, one or more hedging relationships are established by associating financial instruments from database 14 with forecasted transactions from database 16.

In accordance with step 108 of FIG. 2, a financial instrument is selected from database 14 to perform a roll of the forecast for a forecasted transaction selected from database 16 in accordance with step 110. The financial instrument selected is used to generate the date of the new forecast. Although selection of a financial instrument is shown to precede selection of a forecasted transaction in FIG. 2, the respective selections can be made in any order or in parallel.

In step 112, the forecast date for the forecasted transaction is “rolled” to correspond to the reference date of the selected financial instrument. In a preferred embodiment, the new forecast date is the actual reference date of the selected financial instrument.

In step 114, criteria for comparing the original financial instrument and the selected forecasted transaction are determined. These criteria may include: whether the original financial instrument could have served as an effective prospective hedge for the new forecasted transaction (i.e., the selected forecasted transaction with the new forecast date).

In a preferred embodiment, the criteria for comparing the original financial instrument and the new forecasted transaction comply with standards promulgated by the Financial Accounting Standards Board or the DIG that govern accounting for derivative instruments or hedging activities. The criteria of FAS 133, for example, may be selected. FAS 133 requires that a hedging relationship be highly effective (as defined in FAS 133) in order to permit deferral of gain (or loss) on the derivative instrument. The effectiveness of the hedging relationship depends on the correlation between the price movements of the financial instrument and those of the forecasted transaction. A highly effective hedge under the current FAS 133 is one that is at least 80% effective. In determining effectiveness under FAS 133, statistical regression analyses may be employed, such as R-squared, Beta, t-Value, F-Stat, probability and standard error of estimate (or standard deviation). An R-squared value of higher than 0.8 is generally required to meet the “highly effective” test.

The original financial instrument and the new forecasted transaction are then compared using the selected criteria in step 116. In step 118, based on the results of the comparison made in step 116, it is determined whether the original financial instrument would have been a valid hedge for the new forecasted transaction. If so, the amounts of any income (or loss) to be reported to earnings, for the financial instrument that had previously served as a hedge for the original forecasted transaction, and the amount of any income (or loss) to be deferred to OCI may be calculated in step 120. Then, in step 122, the user may compare the selected financial instrument with the new forecasted transaction (with the new forecast date) to determine whether they establish a valid hedging relationship in accordance with the criteria determined in step 114. If the selected financial instrument and the new forecasted transaction establish a valid hedging relationship (step 123), the user may record, or “designate,” a new hedging relationship. The system in step 126 “de-designates” the financial instrument that had previously served as a hedge for the selected forecasted transaction and carries its valid OCI balance calculated in step 120 to the new hedge relationship.

If the original financial instrument would not have been a valid hedge for the new forecasted transaction (see step 118), income or loss associated with that financial instrument is to be reported to earnings in step 129. Also, if the selected financial instrument and the selected forecasted transaction (with the new forecast date) do not establish a valid hedge (see step 123), income or loss associated with the original financial instrument is to be reported to earnings in step 129.

The method then ends in step 128 for valid hedges, or step 130 for hedges that are not valid. The method can thereafter be performed again beginning with step 108 or 110 (or earlier steps 102, 104 or 106).

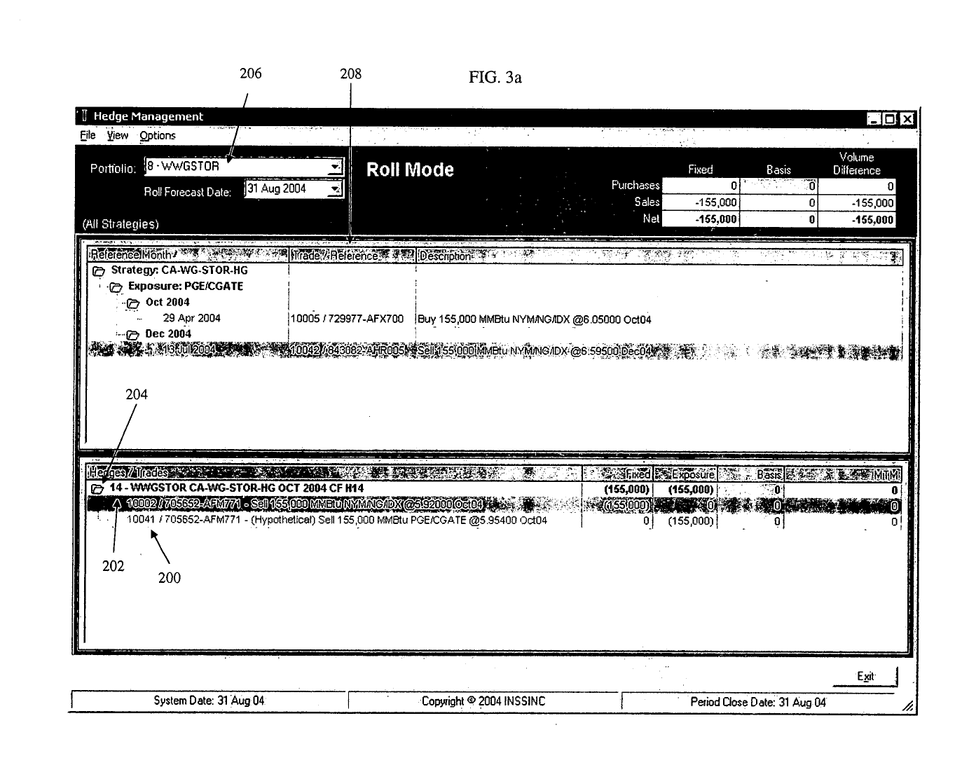

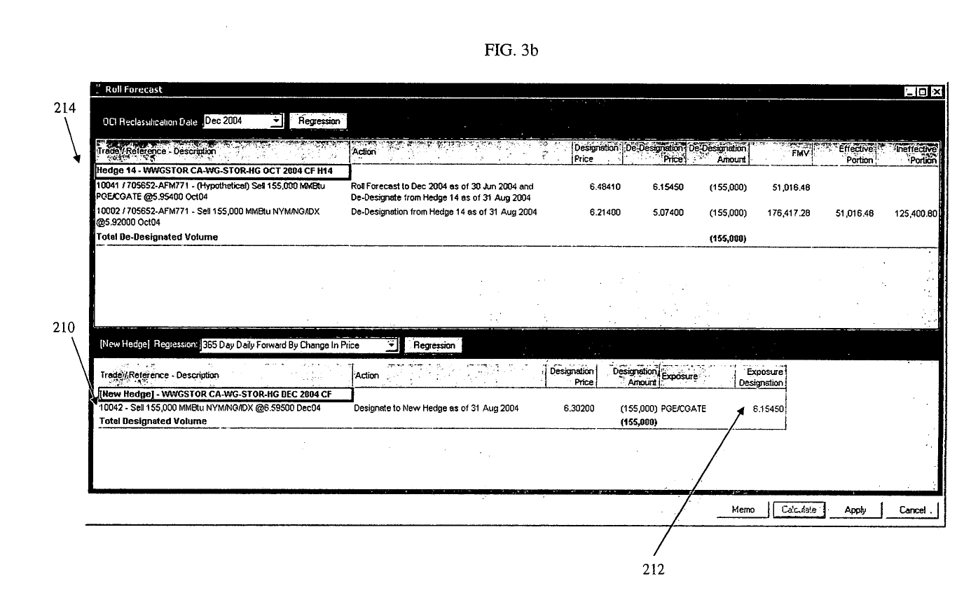

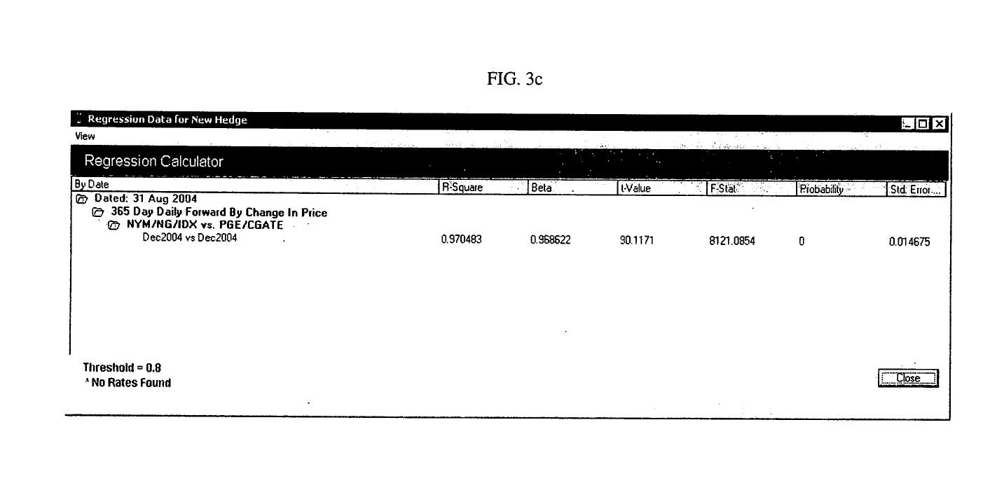

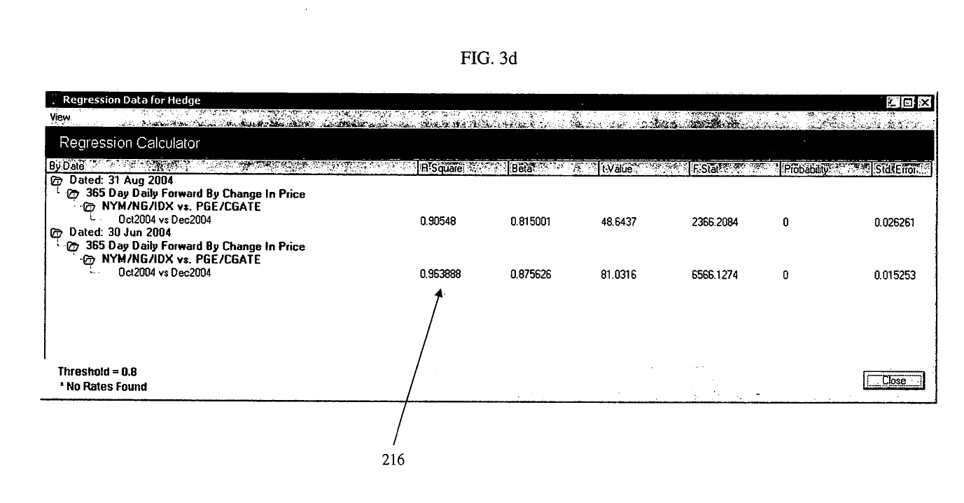

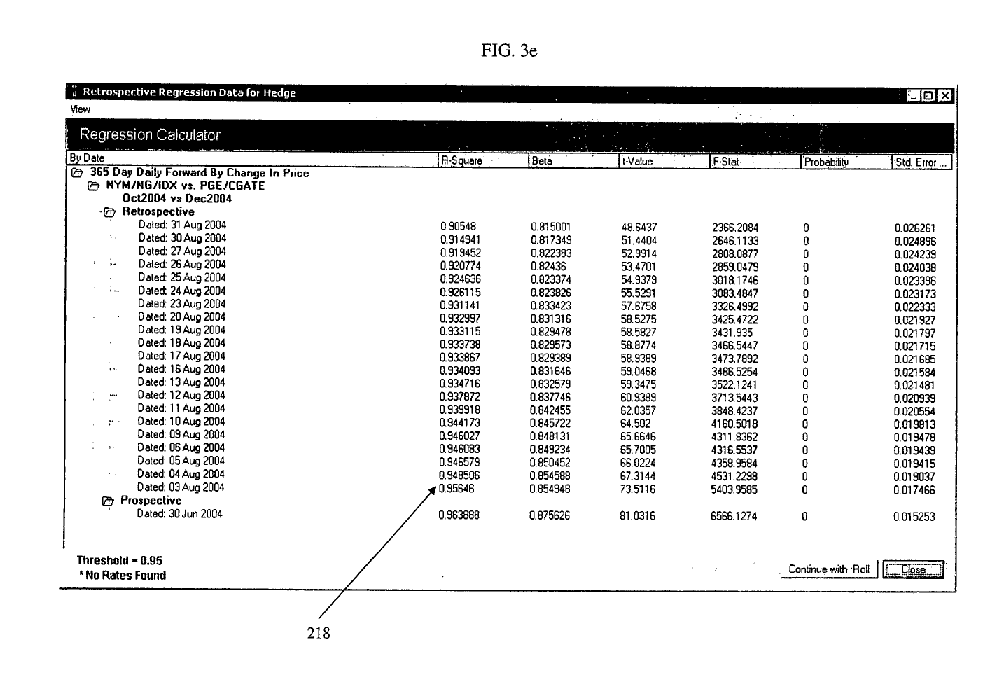

FIGS. 3a through 3e illustrate sample screen shots of a computer-implemented embodiment of the present invention, and can be incorporated into a program such as FUTRAK®, a PC-based risk and hedge management software solution offered by INSSINC and designed for the management of energy, commodities, foreign exchange and interest-rate derivative instruments (such as forwards, futures, options, swaps, caps and floors).

FIG. 3a demonstrates the selection of a financial instrument from a database of financial instruments along with the selection of a forecasted transaction in an existing hedge relationship from a database of forecasted transactions.

In this example, hedges were previously created by matching financial instruments with forecasted transactions, and the hedges were arranged into portfolios according to desired features. The selected forecasted transaction 200 in this example (hypothetical trade #10041) is already linked with a financial instrument 202 (derivative trade #10002) in a hedge 204 (Hedge #14). The user has selected hypothetical trade #10041 by first selecting hedge portfolio #8 (“WWGSTOR”), as indicated in the dropdown box 206 in the upper left-hand corner of the screen, and then selecting Hedge#14 from the “Hedges/Trades” folder in the lower portion of the screen. Hypothetical trade#10041 is the forecasted sale of 155,000 MMBtus of gas from PGE/CGATE in October 2004. The forecasted transaction is hedged with the forward sale of 155,000 MMBtus of gas on NYMEX for October 2004 delivery (derivative trade #10002).

To assess a new potential hedging relationship, the user selects trade #10042 from the list of trades 208 in the upper portion of the screen by highlighting that trade. Highlighted trade #10042 is the forward sale of 155,000 MMBtus of gas on NYMEX for December 2004 delivery.

To effectuate the roll of forecast date, the user drags and drops trade #10042 into Hedge #14, which is presently the hedging relationship between financial instrument #10002 and hypothetical transaction #10041. In a computer-implemented embodiment, such as FUTRAK®, the user may be required to select a particular mode (e.g., “Roll Mode”) to begin the assessment of effectiveness of a new potential hedging relationship. Next, a new window opens, which is shown in FIG. 3b.

In FIG. 3b, the lower portion of the screen 210 displays the new potential hedge consisting of trade #10042 for the sale of gas on NYMEX in December 2004 and an underlying PGE/CGATE exposure. The roll reflects the creation of a new hedging relationship between transaction #10042 and an exposure with a forecast date of December 2004, and the system has generated a new forecast price 212 for the hypothetical sale of gas in December 2004 (which is listed under “Exposure Designation” as 6.15450). The other parameters, i.e., amount to be sold (155,000 MMBtus of gas) and the market for sale (PGE/CGATE), remain the same. The results of a statistical regression analysis on the proposed hedge, comparing price movements in PGE/CGATE gas with price movements in NYMEX gas to assess effectiveness, are also displayed in FIG. 3c. Comparison of those two markets in the regression analysis is appropriate because the new forecasted transaction is for the sale of gas from PGE/CGATE whereas the hedging instrument (trade #10042) is for the sale of gas on NYMEX. The regression data is used to assess prospective effectiveness of the proposed hedge. In this case, because the R-squared value is reported to be greater than 0.97, the hedge is “highly effective” under FAS 133. In addition to the R-squared data, the Beta, t-Value, F-Stat, Probability and Standard Error of Estimation values are calculated and displayed.

The upper portion of the screen 214 in FIG. 3b shows the proposed de-designation of Hedge #14, which would occur upon acceptance of the new hedge. As indicated, trade #10002 and hypothetical transaction #10041 are to be de-designated from Hedge #14 as of the date the forecast date was rolled (in this case, Aug. 31, 2004).

In FIG. 3d, the system conducts retrospective and prospective effectiveness tests for the original hedging instrument (trade #10002), both as of the hedge inception date of Jun. 30, 2004 and as of its de-designation date of Aug. 31, 2004, comparing October price movements in NYMEX gas with December price movements in PGE/CGATE gas to determine whether any gains or losses in fair market value (“FMV”) of the original hedge (trade #10002) can be deferred into OCI. The effectiveness tests determine whether the hedge, if originally entered into on Jun. 30, 2004 with a December exposure (as opposed to the original October exposure), would have been “highly effective.” To make this determination, the system evaluates the correlation between price movements of October 2004 NYMEX gas and price movements of December 2004 PGE/CGATE gas, both at the designation date of the hedge (Jun. 30, 2004) and at the de-designation date of the hedge (Aug. 31, 2004). In the example shown in FIG. 3d, assuming a 0.8 R-squared threshold, the correlations at column 216 between price movements in October 2004 NYMEX gas and December PGE/CGATE gas are sufficiently strong both at designation (0.963888) and de-designation (0.90548) to warrant deferral of any effective portion of gain or loss in FMV of the original hedge (trade #10002).

If different criteria for determining effectiveness had been selected, different designation and de-designation dates would have to be determined to satisfy the effectiveness criteria and permit deferral of income or loss to OCI. For example, if an R-squared threshold of 0.95 or greater were selected, the correlation between price movements of October 2004 NYMEX gas and December 2004 PGE/CGATE gas as of Aug. 31, 2004 would not be sufficiently strong to satisfy the effectiveness criteria (see FIG. 3d). Accordingly, income. (or loss) generated by the derivative up to its de-designation date (Aug. 31, 2004) would have to be reported immediately. To avoid this result, the present invention performs a series of regression tests to determine the de-designation date on which the R-squared value meets the effectiveness criteria. As demonstrated in FIG. 3e, regression tests are conducted on Aug. 30, 2004, Aug. 29, 2004, and so forth, until the correlation between price movements of October 2004 NYMEX gas and December 2004 PGE/CGATE gas is sufficiently strong to yield an R-squared value of 0.95 or greater. As shown in FIG. 3e, this first occurs on Aug. 3, 2004 at cell 218. This date would then be used as the de-designation date in the calculation of change in FMV for the original hedge (trade #10002), to permit deferral of the effective portion of any gain or loss into OCI.

In a similar fashion, the present invention can determine a different original designation date and price if the correlation between price movements in October 2004 NYMEX gas and December 2004 PGE/CGATE gas on Jun. 30, 2004 does not meet previously established effectiveness criteria. (For FIGS. 3d and 3e, this would be the case if an R-squared threshold of 0.97 were chosen.) Regression tests may then be conducted on Jul. 1, 2004, Jul. 2, 2004, and so forth, until the correlation between price movements in October 2004 NYMEX gas and December 2004 PGE/CGATE gas is sufficiently strong to yield an R-squared value exceeding the effectiveness criteria. The date on which the R-squared value satisfies the effectiveness criteria is used as the designation date, to permit deferral of the effective portion of any gain or loss into OCI on the hedge.

By selecting designation and de-designation dates on which R-squared values satisfy previously established effectiveness criteria, the present invention can be used to minimize unfavorable accounting treatment of income (loss) through deferral to OCI.

Once the designation and de-designation dates have been selected, changes in FMV are determined both for the forecasted exposure (trade #10041) and for the derivative (trade #10002). To calculate the change in FMV for the hypothetical transaction (trade #10041, FIG. 3b), the system subtracts the market price for December 2004 PGE/CGATE gas at the designation date of Hedge #14 (Jun. 30, 2004 in this case, see FIGS. 3b-3d) from the market price for December 2004 PGE/CGATE gas as of de-designation of Hedge #14 (Aug. 31, 2004, see FIGS. 3b-3d), multiplies the result by the quantity (here 155,000 MMBtus) and then multiplies that result by a discount factor, which reflects the time value of money. The discount factor is calculated using historical interest rate and commodity price data. In this case, the change in FMV for the hypothetical transaction (trade #10041) is a gain of 51,016.48, as shown in FIG. 3b.

The change in fair market value for the hedge (trade #10002) is calculated by subtracting the market price for October 2004 gas on NYMEX as of the designation date of Hedge #14 from the market price for NYMEX October 2004 gas as of de-designation, multiplying the result by the quantity (here 155,000 MMBtus) and then multiplying that result by the discount factor. In this case, the change in FMV for the hedge (trade #10002) is a gain of 176,417.28 (FIG. 3b).

Because the gain on the derivative exceeds the gain on the hypothetical trade #100.41 (51,016.48), the derivative is not fully effective, and only the change in FMV of 51,016.48 (effective portion) can be recognized into OCI for reclassification in December 2004. That portion of OCI is then carried into the new hedging relationship, to be reclassified into earnings in December 2004. An ineffective portion of 125,400.80 (176,417.28−51,016.48) would have to be recognized immediately into earnings.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer-implemented method for identifying pairings of transactions that establish valid hedging relationships in compliance with hedge-accounting criteria and for determining eligibility of financial instruments for hedge-accounting treatment, comprising:
a. accessing one or more computer databases containing one or more financial instruments and one or more forecasted transactions;
b. selecting a financial instrument as a potential hedge from the one or more financial instruments;
c. selecting a forecasted transaction already associated with a financial instrument in a hedging relationship from the forecasted transactions;
d. generating a new forecasted transaction to be associated with the selected financial instrument;
e. processing data associated with the selected financial instrument and data associated with the new forecasted transaction in accordance with hedge-accounting criteria to generate first hedging data indicative of whether the selected financial instrument and the new forecasted transaction establish a valid hedging relationship in accordance with the hedge-accounting criteria;
f. processing data associated with the financial instrument originally associated with the selected forecasted transaction and data associated with the new forecasted transaction in accordance with hedge-accounting criteria to generate second hedging data indicative of whether the financial instrument originally associated with the selected forecasted transaction establishes or would have established a valid hedging relationship with the new forecasted transaction in accordance with the. hedge-accounting criteria; and
g. designating the selected financial instrument as a hedge for the new forecasted transaction if the first and second hedging data indicate the existence of valid hedging relationships.

2. The method of claim 1, wherein the new forecasted transaction includes a forecast date that corresponds to the reference date for the selected financial instrument.

3. The method of claim 1, further comprising de-designating the hedging relationship between the selected forecasted transaction and its associated financial instrument upon designating the selected financial instrument as a hedge for the new forecasted transaction.

4. The method of claim 1, wherein one or more of the financial instruments and the forecasted transactions are displayed on a display device for viewing and selection by a user.

5. The method of claim 4, wherein a user selects and drags an indicia of the selected financial instrument to a screen location associated with the selected forecasted transaction to thereby trigger the generation of the new forecasted transaction.

6. The method of claim 1, wherein the hedge-accounting criteria comply with standards promulgated by one or more of the Financial Accounting Standards Board or the DIG to govern accounting for derivative instruments or hedging activities.

7. The method of claim 6, wherein the hedge-accounting criteria comprise criteria for determining the effectiveness of the hedging relationships.

8. The method of claim 7, wherein the processing of data includes a statistical regression analysis to determine the effectiveness of the hedging relationships.

9. The method of claim 8, wherein the statistical regression analysis generates an R-squared value.

10. The method of claim 1, wherein the processing of data associated with the financial instrument originally associated with the selected forecasted transaction and data associated with the new forecasted transaction includes one or more calculations using, as a designation date for the financial instrument, the hedge inception date for the financial instrument and its associated selected forecasted transaction.

11. The method of claim 1, wherein the processing of data associated with the financial instrument originally associated with the selected forecasted transaction and data associated with the new forecasted transaction includes one or more calculations using, as a de-designation date for the financial instrument, the proposed or actual designation date for the hedge consisting of the selected financial instrument and the new forecasted transaction.

12. The method of claim 1, wherein the processing of data associated with the financial instrument originally associated with the selected forecasted transaction and data associated with the new forecasted transaction includes one or more calculations using, as a designation date for the financial instrument, the hedge inception date for the financial instrument and its associated selected forecasted transaction and one or more calculations using, as a de-designation date for the financial instrument, the actual or proposed designation date for the hedge consisting of the selected financial instrument and the new forecasted transaction.

13. The method of claim 12, wherein, if the second hedging data does not indicate the existence of a valid hedging relationship, additional processing is performed using one or more additional designation dates for the financial instrument originally associated with the selected forecasted transaction to determine whether, if such designation dates are selected, the financial instrument originally associated with the selected forecasted transaction establishes or would have established a valid hedging relationship with the new forecasted transaction in accordance with the hedge-accounting criteria.

14. The method of claim 13, wherein the designation dates used in the processing of data are sequential.

15. The method of claim 14, wherein the designation dates used in the processing of data are consecutive.

16. The method of claim 12, wherein, if the second hedging data does not indicate the existence of a valid hedging relationship, additional processing is performed using one or more additional de-designation dates for the financial instrument originally associated with the selected forecasted transaction to determine whether, if such de-designation dates are selected, the financial instrument originally associated with the selected forecasted transaction establishes or would have established a valid hedging relationship with the new forecasted transaction in accordance with the hedge-accounting criteria.

17. The method of claim 16, wherein the de-designation dates used in the processing of data are sequential.

18. The method of claim 17, wherein the de-designation dates used in the processing of data are consecutive.

19. The method of claim 1, wherein the processing of data associated with the financial instrument originally associated with the selected forecasted transaction and data associated with the new forecasted transaction includes calculations using two or more different designation dates for the financial instrument.

20. The method of claim 19, wherein the new forecasted transaction includes a forecast date that corresponds to the reference date for the selected financial instrument.

21. The method of claim 19, wherein the two or more different designation dates are sequential.

22. The method of claim 21, wherein the two or more different designation dates are consecutive.

23. The method of claim 1, wherein the processing of data associated with the financial instrument originally associated with the selected forecasted transaction and data associated with the new forecasted transaction includes calculations using two or more different de-designation dates for the financial instrument.

24. The method of claim 23, wherein the new forecasted transaction includes a forecast date that corresponds to the reference date for the selected financial instrument.

25. The method of claim 23, wherein the two or more different de-designation dates are sequential.

26. The method of claim 25, wherein the two or more different de-designation dates are consecutive.

27. The method of claim 1, wherein a designation date and a de-designation date for the financial instrument originally associated with the selected forecasted transaction are selected so that the financial instrument establishes or would have established a valid hedging relationship with the new forecasted transaction in accordance with the hedge-accounting criteria.

28. The method of claim 1, wherein a designation date and a de-designation date of the financial instrument originally associated with the selected forecasted transaction are selected so as to reduce gain or loss on the financial instrument.

29. The method of claim 1, wherein a designation date and a de-designation date of the financial instrument originally associated with the selected forecasted transaction are selected so as to minimize gain or loss on the financial instrument.

30. A system for identifying pairings of transactions that establish valid hedging relationships in compliance with hedge-accounting criteria and for determining eligibility of financial instruments for hedge-accounting treatment, comprising a computer, in communication with one or more databases and a user input device, comprising a microprocessor; the one or more databases storing one or more financial instruments and one or more forecasted transactions; and wherein the microprocessor is programmed to:
a. allow a user to select a financial instrument as a potential hedge from the one or more financial instruments;
b. allow a user to select a forecasted transaction already associated with a financial instrument in a hedging relationship from the forecasted transactions;
c. generate a new forecasted transaction to be associated with the selected financial instrument;
d. process data associated with the selected financial instrument and data associated with the new forecasted transaction in accordance with hedge-accounting criteria to generate first hedging data indicative of whether the selected financial instrument and the new forecasted transaction establish a valid hedging relationship in accordance with the hedge-accounting criteria;
e. process data associated with the financial instrument originally associated with the selected forecasted transaction and data associated with the new forecasted transaction in accordance with hedge-accounting criteria to generate second hedging data indicative of whether the financial instrument originally associated with the selected forecasted transaction establishes or would have established a valid hedging relationship with the new forecasted transaction in accordance with the hedge-accounting criteria; and
f. allow a user to designate the selected financial instrument as a hedge for the new forecasted transaction if the first and second hedging data indicate the existence of valid hedging relationships.

31. The system of claim 30, wherein the new forecasted transaction includes a forecast date that corresponds to the reference date for the selected financial instrument.

32. The system of claim 30, wherein the microprocessor is further programmed to de-designate the hedging relationship between the selected forecasted transaction and its associated financial instrument upon designation of the selected financial instrument as a hedge for the new forecasted transaction.

33. The system of claim 30, wherein the microprocessor is further programmed to display one or more of the financial instruments and the forecasted transactions on a display device for viewing and selection by a user.

34. The system of claim 33, wherein the microprocessor is further programmed to allow a user to select and drag an indicia of the selected financial instrument to a screen location associated with the selected forecasted transaction to thereby trigger the generation of the new forecasted transaction.

35. The system of claim 30, wherein the hedge-accounting criteria comply with standards promulgated by one or more of the Financial Accounting Standards Board or the DIG to govern accounting for derivative instruments or hedging activities.

36. The system of claim 35, wherein the hedge-accounting criteria comprise criteria for determining the effectiveness of the hedging relationships.

37. The system of claim 36, wherein the processing of data includes a statistical regression analysis to determine the effectiveness of the hedging relationships.

38. The system of claim 37, wherein the statistical regression analysis generates an R-squared value.

39. The system of claim 30, wherein the processing of data associated with the financial instrument originally associated with the selected forecasted transaction and data associated with the new forecasted transaction includes one or more calculations using, as a designation date for the financial instrument, the hedge inception date for the financial instrument and its associated selected forecasted transaction.

40. The system of claim 30, wherein the processing of data associated with the financial instrument originally associated with the selected forecasted transaction and data associated with the new forecasted transaction includes one or more calculations using, as a de-designation date for the financial instrument, the proposed or actual designation date for the hedge consisting of the selected financial instrument and the new forecasted transaction.

41. The system of claim 30, wherein the processing of data associated with the financial instrument originally associated with the selected forecasted transaction and data associated with the new forecasted transaction includes one or more calculations using, as a designation date for the financial instrument, the hedge inception date for the financial instrument and its associated selected forecasted transaction and one or more calculations using, as a de-designation date for the financial instrument, the actual or proposed designation date for the hedge consisting of the selected financial instrument and the new forecasted transaction.

42. The system of claim 30, wherein the processing of data associated with the financial instrument originally associated with the selected forecasted transaction and data associated with the new forecasted transaction includes calculations using two or more different designation dates for the financial instrument.

43. The system of claim 42, wherein the new forecasted transaction includes a forecast date that corresponds to the reference date for the selected financial instrument.

44. The system of claim 42, wherein the two or more different designation dates are sequential.

45. The system of claim 44, wherein the two or more different designation dates are consecutive.

46. The system of claim 30, wherein the processing of data associated with the financial instrument originally associated with the selected forecasted transaction and data associated with the new forecasted transaction includes calculations using two or more different de-designation dates for the financial instrument.

47. The system of claim 46, wherein the new forecasted transaction includes a forecast date that corresponds to the reference date for the selected financial instrument.

48. The system of claim 46, wherein the two or more different de-designation dates are sequential.

49. The system of claim 48, wherein the two or more different de-designation dates are consecutive.

50. The system of claim 30, wherein the microprocessor is further programmed to allow a user to select a designation date and a de-designation date for the financial instrument originally associated with the selected forecasted transaction so that the financial instrument establishes or would have established a valid hedging relationship with the new forecasted transaction in accordance with the hedge-accounting criteria.

51. The system of claim 30, wherein the microprocessor is further programmed to allow a user to select a designation date and a de-designation date of the financial instrument originally associated with the selected forecasted transaction so as to reduce gain or loss on the financial instrument.

52. The system of claim 30, wherein the microprocessor is further programmed to allow a user to select a designation date and a de-designation date of the financial instrument originally associated with the selected forecasted transaction so as to minimize gain or loss on the financial instrument.

53. A computer-readable storage medium storing a program for instructing a computer to execute actions, the actions comprising:
a. requesting a user to select a financial instrument as a potential hedge from one or more financial instruments in one or more computer databases;
b. requesting the user to select a forecasted transaction already associated with a financial instrument in a hedging relationship from one or more forecasted transactions in the one or more computer databases;
c. generating a new forecasted transaction to be associated with the selected financial instrument;
d. processing data associated with the selected financial instrument and data associated with the new forecasted transaction in accordance with hedge-accounting criteria to generate first hedging data indicative of whether the selected financial instrument and the new forecasted transaction establish a valid hedging relationship in accordance with the hedge-accounting criteria;
e. processing data associated with the financial instrument originally associated with the selected forecasted transaction and data associated with the new forecasted transaction in accordance with hedge-accounting criteria to generate second hedging data indicative of whether the financial instrument originally associated with the selected forecasted transaction establishes or would have established a valid hedging relationship with the new forecasted transaction in accordance with the hedge-accounting criteria; and
f. allowing a user to designate the selected financial instrument as a hedge for the new forecasted transaction if the first and second hedging data indicate the existence of valid hedging relationships.

54. The computer-readable storage medium of claim 53, wherein the new forecasted transaction includes a forecast date that corresponds to the reference date for the selected financial instrument.

55. The computer-readable storage medium of claim 53, the actions further comprising de-designating the hedging relationship between the selected forecasted transaction and its associated financial instrument upon designation of the selected financial instrument as a hedge for the new forecasted transaction.

56. The computer-readable storage medium of claim 53, the actions further comprising displaying one or more of the financial instruments and the forecasted transactions on a display device for viewing and selection by a user.

57. The computer-readable storage medium of claim 56, the actions further comprising allowing a user to select and drag an indicia of the selected financial instrument to a screen location associated with the selected forecasted transaction to thereby trigger the generation of the new forecasted transaction.

58. The computer-readable storage medium of claim 53, wherein the hedge-accounting criteria comply with standards promulgated by one or more of the Financial Accounting Standards Board or the DIG to govern accounting for derivative instruments or hedging activities.

59. The computer-readable storage medium of claim 58, wherein the hedge-accounting criteria comprise criteria for determining the effectiveness of the hedging relationships.

60. The computer-readable storage medium of claim 59, wherein the processing of data includes a statistical regression analysis to determine the effectiveness of the hedging relationships.

61. The computer-readable storage medium of claim 60, wherein the statistical regression analysis generates an R-squared value.

62. The computer-readable storage medium of claim 53, wherein the processing of data associated with the financial instrument originally associated with the selected forecasted transaction and data associated with the new forecasted transaction includes one or more calculations using, as a designation date for the financial instrument, the hedge inception date for the financial instrument and its associated selected forecasted transaction.

63. The computer-readable storage medium of claim 53, wherein the processing of data associated with the financial instrument originally associated with the selected forecasted transaction and data associated with the new forecasted transaction includes one or more calculations using, as a de-designation date for the financial instrument, the proposed or actual designation date for the hedge consisting of the selected financial instrument and the new forecasted transaction.

64. The computer-readable storage medium of claim 53, wherein the processing of data associated with the financial instrument originally associated with the selected forecasted transaction and data associated with the new forecasted transaction includes one or more calculations using, as a designation date for the financial instrument, the hedge inception date for the financial instrument and its associated selected forecasted transaction and one or more calculations using, as a de-designation date for the financial instrument, the actual or proposed designation date for the hedge consisting of the selected financial instrument and the new forecasted transaction.

65. The computer-readable storage medium of claim 53, wherein the processing of data associated with the financial instrument originally associated with the selected forecasted transaction and data associated with the new forecasted transaction includes calculations using two or more different designation dates for the financial instrument.

66. The computer-readable storage medium of claim 65, wherein the new forecasted transaction includes a forecast date that corresponds to the reference date for the selected financial instrument.

67. The computer-readable storage medium of claim 65, wherein the two or more different designation dates are sequential.

68. The computer-readable storage medium of claim 67, wherein the two or more different designation dates are consecutive.

69. The computer-readable storage medium of claim 53, wherein the processing of data associated with the financial instrument originally associated with the selected forecasted transaction and data associated with the new forecasted transaction includes calculations using two or more different de-designation dates for the financial instrument.

70. The computer-readable storage medium of claim 69, wherein the new forecasted transaction includes a forecast date that corresponds to the reference date for the selected financial instrument.

71. The computer-readable storage medium of claim 69, wherein the two or more different de-designation dates are sequential.

72. The computer-readable storage medium of claim 71, wherein the two or more different de-designation dates are consecutive.

73. The computer-readable storage medium of claim 53, the actions further comprising allowing a user to select a designation date and a de-designation date for the financial instrument originally associated with the selected forecasted transaction so that the financial instrument establishes or would have established a valid hedging relationship with the new forecasted transaction in accordance with the hedge-accounting criteria.

74. The computer-readable storage medium of claim 53, the actions further comprising allowing a user to select a designation date and a de-designation date for the financial instrument originally associated with the selected forecasted transaction so as to reduce gain or loss on the financial instrument.

75. The computer-readable storage medium of claim. 53, the actions further comprising allowing a user to select a designation date and a de-designation date for the financial instrument originally associated with the selected forecasted transaction so as to minimize gain or loss on the financial instrument.
